(19) United States
(12) Patent Application Publication
(10) Pub. No.: US 2010/0283266 A1
(43) Pub. Date: Nov. 11, 2010

(54) MAGNETIC FIELD POWERED ELECTRICAL GENERATING SYSTEM

(75) Inventors: Zeeshan Shafiq, Pac Kamra (PK); M. Saleem Tahir, Jung (PK); Salman Mahmood, Worcester Park (UK)

Correspondence Address: KATTEN MUCHIN ROSENMAN LLP, 575 MADISON AVENUE, NEW YORK, NY, 10022-2585, US

(73) Assignee: AVEROX NORTH AMERICA INC., Novi, MI (US)

(21) Appl. No.: 12/436,281

(22) Filed: May 6, 2009

(51) Int. Cl. H02N 11/00; H02K 53/00

(52) U.S. Cl. 290/36 R; 290/1 R; 74/DIG. 9

(57) ABSTRACT

A system for generating electricity is provided. The system uses magnetic and potential energy inherent in the magnets and weight of a magnet wheel of a magnetic drive unit which converts this energy into kinetic energy and torque applied to a drive shaft, which then drives an electrical alternator. The magnetic wheel is a fly wheel made from non-magnetic material having a unique arrangement of magnets around its periphery. An electromagnet is powered by a switch that is activated by a magnetic flux of permanent magnets arranged on the magnet wheel. Once the wheel and drive shaft are rotating at a steady-state rotational speed, the pulsating excitation of electromagnets pulls the permanent magnets on the magnet wheel, which keeps the wheel and ultimately the integral drive shaft rotating. The rotation of the drive shaft enables the alternator to generate electricity.

### FIELD OF THE INVENTION

The invention relates to a system and a method of generating electrical current using a magnetic field.

### BACKGROUND OF THE INVENTION

The economies and the financial systems of this modern, global, developed and mechanized world are escalating continuously and ultimately they are in need of an inexpensive, plentiful, and readily available source of energy to power their machinery and industry. This energy has been supplied for the last hundred years for the conventional different combustion engines, electric motors and generators. The fundamental concept of all these methods has been to convert potential energy found in nature into the kinetic energy of the torque of a rotating drive shaft which in turn generates electricity, operates a machine in the industry or spins a wheeled axle. The source for this power has generally been the fossil fuels originating in the nature like oil, gas, coal and wood, and these sources have been used because of their availability in abundance and easy extraction of energy. Regrettably, the use of these fossil fuels have led to two major environmental problems; environmental damage and health issues resulting from the pollution in the atmosphere which is caused by the green gases these fossil fuels emit when burned.

Consequently, to meet the growing demands of electricity and to counteract shortages and massive price rises in oil and gas, the present inventors have recognized the need for a new and a better way to supply energy, which is equally efficient and more environment friendly. Accordingly, the present inventors have developed a design for electrical generators which can run without any fossil fuels found in nature and which do not require the production of greenhouse gases.

### SUMMARY OF THE INVENTION

In one aspect, the invention provides a system for generating electrical current. The system comprises first wheel comprising a non-magnetic material; a drive shaft connected to the first wheel; a plurality of permanent magnets, each of the plurality of permanent magnets being affixed to a respective interior portion of a periphery of the first wheel; a first magnetic flux switch positioned parallel to the drive shaft and at a first predetermined distance from a center of the first wheel; a first electromagnet positioned parallel to the drive shaft and at a second predetermined distance from the center of the first wheel, the electromagnet being electrically coupled to the magnetic flux switch; an alternator connected to the drive shaft, the alternator having an output port; and a starter connected to the drive shaft.

When the first wheel rotates about an axis of the drive shaft, as one of the plurality of permanent magnets approaches the first magnetic flux switch, the first magnetic flux switch is configured to close, thereby causing the first electromagnet to be electrically energized, thereby causing the one of the plurality of permanent magnets to move away from the first magnetic flux switch and toward the first electromagnet, thereby causing the first magnetic flux switch to open, thereby causing the first electromagnet to be de-energized. An inertia caused by motion of the plurality of permanent magnets causes the drive shaft to rotate, thereby causing the alternator to generate electrical current, and wherein the alternator is further configured to output the generated electrical current via the output port.

The system may further comprise a starting means coupled to the drive shaft. The starting means may be configured to apply an initial torque to the drive shaft. The system may further comprise a controller and a battery. The controller may be coupled to the starting means, the alternator, the first magnetic flux switch, and the first electromagnet. The battery may be coupled to the controller. The controller may be configured to provide a start signal to the starting means and to monitor an operation of the system. The battery may be configured to provide power to the starting means for applying the initial torque and to provide a backup source of power to the system. When the first wheel rotates at a rate greater than or equal to a predetermined minimum steady-state rate, an efficiency of outputted generated electrical current may be optimized.

The plurality of permanent magnets may include a plurality of bar magnets positioned in an approximately equal mutual spacing arrangement along the periphery of the first wheel. The plurality of permanent magnets may include at least twelve bar magnets. Alternatively, the plurality of permanent magnets may include a plurality of cylindrical magnets positioned in an approximately equal mutual spacing arrangement along the periphery of the first wheel.

The system may further comprise a second wheel, a second magnetic flux switch, and a second electromagnet, each being configured substantially identically as the first wheel, the first magnetic flux switch, and the first electromagnet, respectively. The system may further comprise a third wheel, a third magnetic flux switch, and a third electromagnet, each being configured substantially identically as the first wheel, the first magnetic flux switch, and the first electromagnet, respectively.

The plurality of permanent magnets may include a first plurality of cylindrical magnets positioned in an approximately equal mutual spacing arrangement along the periphery of the first wheel and a second plurality of cylindrical magnets positioned in an approximately equal mutual spacing arrangement along the periphery of the second wheel and a third plurality of cylindrical magnets positioned in an approximately equal mutual spacing arrangement along the periphery of the third wheel. Each of the first, second, and third pluralities of cylindrical magnets may include at least 45 cylindrical magnets. Each of the plurality of permanent magnets comprises a rare earth metal magnet. The rare earth metal magnets may be selected from the group consisting of samarium-cobalt magnets and neodymium-iron-boron magnets.

In another aspect, the invention provides a method of using a first wheel, an electromagnet, a magnetic flux switch, and an alternator to generate electrical current. Each of the first wheel and the alternator is mechanically coupled to a drive shaft. The magnetic flux switch is positioned parallel to the drive shaft and at a first predetermined distance from a center of the first wheel. The electromagnet is positioned parallel to the drive shaft and at a second predetermined distance from the center of the first wheel. The electromagnet is electrically coupled to the magnetic flux switch. The first wheel includes a plurality of permanent magnets. Each of the plurality of permanent magnets is affixed to a respective interior portion of a periphery of the first wheel.

The method comprises the steps of: applying an initial torque to the drive shaft; and monitoring a rotational rate of the drive shaft. When the drive shaft rotates, the drive shaft is configured to cause the first wheel to rotate about an axis of the drive shaft at a same rotational rate, thereby causing one of the plurality of permanent magnets to approach the magnetic flux switch, thereby causing the magnetic flux switch to close, thereby causing the electromagnet to be electrically energized, thereby causing the one of the plurality of permanent magnets to move away from the magnetic flux switch and toward the electromagnet, thereby causing the magnetic flux switch to open, thereby causing the electromagnet to be de-energized. An inertia caused by motion of the plurality of permanent magnets causes the drive shaft to rotate, thereby causing the alternator to generate electrical current.

The method may further comprise the step of using a battery to provide power for applying an initial torque and for providing a backup source of power. When the first wheel rotates at a rate greater than or equal to a predetermined minimum steady-state rate, an efficiency of generated electrical current may be optimized.

The plurality of permanent magnets may include a plurality of bar magnets positioned in an approximately equal mutual spacing arrangement along the periphery of the first wheel. The plurality of bar magnets may include at least twelve bar magnets. Alternatively, the plurality of permanent magnets may include a plurality of cylindrical magnets positioned in an approximately equal mutual spacing arrangement along the periphery of the first wheel.

In yet another aspect, the invention provides a method of using a plurality of wheels, a corresponding plurality of electromagnets, a corresponding plurality of magnetic flux switches, and an alternator to generate electrical current. Each of the plurality of wheels and the alternator is mechanically coupled to a drive shaft. Each of the plurality of magnetic flux switches is positioned parallel to the drive shaft and at a first predetermined distance from a center of a corresponding one of the plurality of wheels. Each of the plurality of electromagnets is positioned parallel to the drive shaft and at a second predetermined distance from the center of a corresponding one of the plurality of wheels. Each of the plurality of electromagnets is electrically coupled to the corresponding one of the plurality of magnetic flux switches. Each of the plurality of wheels includes a corresponding plurality of permanent magnets. Each of the pluralities of permanent magnets is affixed to a respective interior portion of a periphery of the corresponding one of the plurality of wheels.

The method comprises the steps of: applying an initial torque to the drive shaft; and monitoring a rotational rate of the drive shaft. When the drive shaft rotates, the drive shaft is configured to cause each of the plurality of wheels to rotate about an axis of the drive shaft at a same rotational rate, thereby causing one of each of the pluralities of permanent magnets to approach the corresponding one of the plurality of magnetic flux switches, thereby causing each of the plurality of magnetic flux switches to close, thereby causing the corresponding one of the plurality of electromagnets to be electrically energized, thereby causing the one of each of the pluralities of permanent magnets to move away from the corresponding magnetic flux switch and toward the corresponding electromagnet, thereby causing the corresponding magnetic flux switch to open, thereby causing the corresponding electromagnet to be de-energized. An inertia caused by motion of the pluralities of permanent magnets causes the drive shaft to rotate, thereby causing the alternator to generate electrical current.

Each of the pluralities of permanent magnets may include a plurality of cylindrical magnets positioned in an approximately equal mutual spacing arrangement along the periphery of the corresponding wheel. Each of the pluralities of cylindrical magnets may include at least 45 cylindrical magnets. Each of the plurality of permanent magnets may comprise a rare earth metal magnet, such as, for example, a rare earth metal magnet selected from the group consisting of samarium-cobalt magnets and neodymium-iron-boron magnets.

### BRIEF DESCRIPTION OF THE DRAWINGS

FIG. 1 illustrates a block diagram of a preferred embodiment of a magnetic field-powered electrical generating system according to a preferred embodiment of the present invention.

FIG. 2 illustrates a side view of a magnetic drive unit according to a preferred embodiment of the present invention.

FIG. 3 illustrates a front view of a flywheel with permanent magnets positioned along its periphery according to a preferred embodiment of the present invention.

FIG. 4 illustrates a block diagram of top view of a magnetic drive unit according to a preferred embodiment of the present invention.

### DETAILED DESCRIPTION OF THE INVENTION

The magnetism in any material arises from the arrangement of dipoles in similar direction. In ordinary materials, these dipoles are randomly orientated, thus yielding no magnetic effect on the average. Permanent magnets, by contrast, have magnetic poles arranged in such a manner that the magnetic effect from each dipole is added to one another, thereby resulting in a strong magnetic field. This similar alignment of the magnetic dipoles is a form of potential energy and can be used to get useful energy from the system.

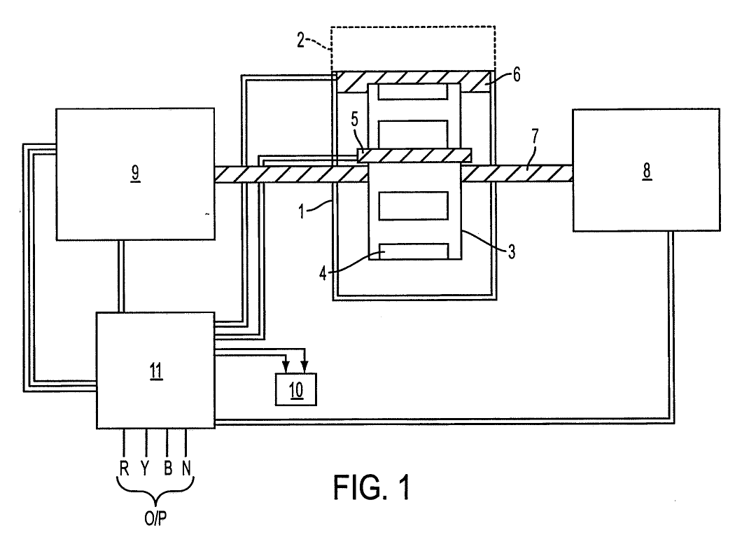

Referring to FIG. 1, the design of a preferred embodiment of the present invention utilizes this potential or magnetic energy of the material for producing mechanical energy which is later converted into electrical energy, thus forming a Magnetic Field Powered Electrical Generating System. The magnetic drive unit 1 is capable of not only sustaining rotations even when the load is applied on the system, but can also produce mechanical power, which is later converted to electrical power, in the most environment friendly way.

The basic idea of the system is to produce rotating torque by placing an electromagnet 6 at a predetermined stationary position and then energizing the electromagnet 6 to produce an attractive force for a permanent magnet 4 on the periphery of the rotating flywheel 3 and then, as the magnet 4 passes by the electromagnet 6, de-energizing the electromagnet 6. This step is repeated for a predetermined number of times each cycle to sustain the rotation and to continue providing the force to the outside load. The size, design arrangement, and number of magnets 4 can be changed according to the availability and ease in the commercial level production.

In a preferred embodiment, the generating system may be started manually. Once the flywheel 3 reaches a predetermined minimum rotational rate, the system commences producing electricity in the form of electrical current, which can then be used for not only commercial, industrial loads but can also be used for domestic requirements, as the system is very low noise and has no emissions. In addition, the system requires no external input or source for working like wind for wind turbines, sun for solar cells etc.; instead, the permanent magnets 4 serve as a source of energy that is generally sufficient to enable the system to continually operate in working conditions.

Once this system is started, it can continually operate for quite a long time and needs only to be switched off for maintenance of moving mechanical parts and electrical equipment.

The system is designed to work at a rated rotational speed which can be in accordance with an alternator 9 whose output is directly usable, thus reducing the electrical losses and circuitry.

The system requires a starting torque. In a preferred embodiment, a starter motor 8 powered by battery 10 is used to apply a starting torque to a drive shaft 7 and to increase its rotational rate up to the rated speed. In alternative embodiments, other options are also available, including the manual starting of the system using string rotated on some flywheel, some paddle arrangement, or simply some gasoline engine.

In a preferred embodiment of the invention, the system comprises a magnetic drive unit 1, a starter arrangement 8, an alternator 9, a controller 11, and a drive shaft 7.

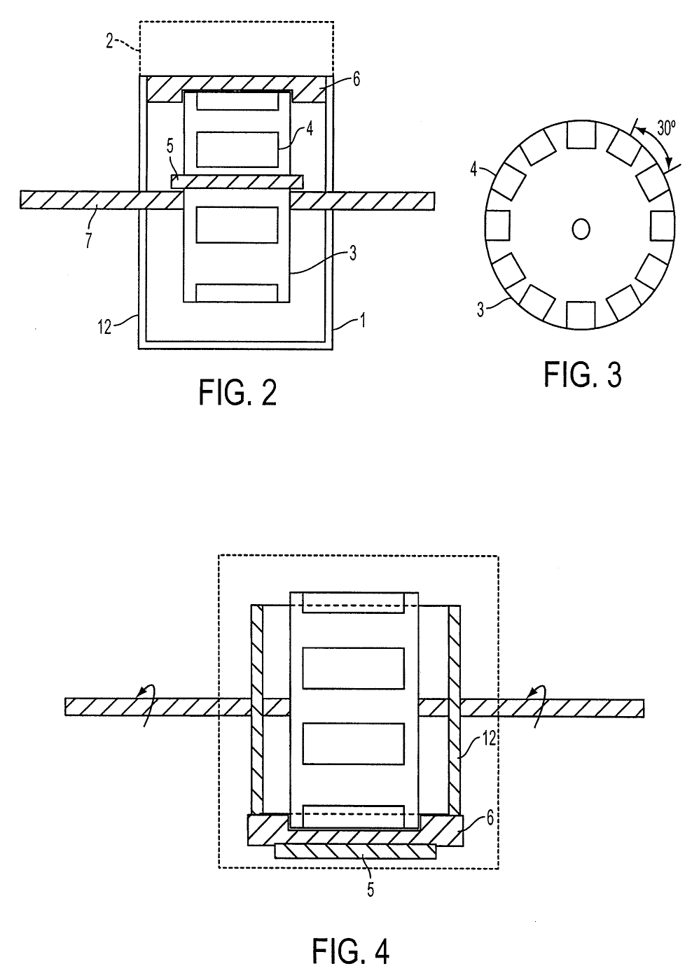

Referring also to FIGS. 2 and 4, the magnetic drive unit 1 servers as the driving force of the whole system. The magnetic drive unit 1 comprises several constituent parts. A magnet wheel 3 includes a unique arrangement of permanent magnets 4 positioned inside the periphery of the wheel 3. The weight of the wheel 3 and the stored magnetic energy of the magnets 4 correspond to the output power of the complete system. These dimensions are set according to the materials type and availability.

An electromagnet 6 is attached on the top of a stand 12 having dimensions in accordance with the magnet wheel 3. The electromagnet 6 is powered by a battery 10 through a magnetic flux switch 5. The electromagnet 6 is activated when one of the permanent magnets 4, positioned inside the periphery of the magnet wheel 3, approaches the magnetic flux switch 5. The magnetic flux switch 5 is attached at side of the stand 12. A cover 2 is positioned on the whole unit and is electrically grounded as a precaution for safety. The magnet wheel 3 is initially rotated by action of the starter arrangement 8.

The starter arrangement 8 provides the starting torque to the system. A motor and coupling arrangement are provided in the starter 8 powered by a battery 10. In a preferred embodiment, the motor is a squirrel cage type commonly found in the stator of an automobile. The coupling arrangement comprises of a relay that couples the shaft of the starter motor with the driving shaft 7 when the system is given a starting signal. The relay decouples the starter motor shaft from the driving shaft after the alternator 9 begins its operation.

The alternator 9 is the electrical generating unit of the system that converts the mechanical energy delivered by the drive shaft into electrical energy using conventional electrical machine design. The electrical energy is generated in the form of three phase alternating current. The system is designed to work at the rated rotational speed of the alternator 9. The rated rotational speed is initially by action of the starter 8 and then sustained by action of the magnetic drive unit 1.

The controller 11 is the main controlling unit of the system. The controller 11 comprises electronic circuitry, switches, relays and breakers. One function of the controller 11 is to initiate the starting signal which couples the starter 8 with the drive shaft 7. The controller 1 also monitors the rotational speed of the drive shaft 7 until the required rotational speed is attained and system becomes stable. The controller 11 also decouples the starter 8 from the drive shaft 7, starts the charging of the battery 10, and configures the system to take the load.

The drive shaft 7 serves as the mechanical coupling link between various parts of the system, thus synchronizing the system and transfer mechanical energy from the magnetic drive unit 1 to the alternator 9, where it is converted to useful electrical power.

When the system is switched on, the controller 11 produces a starting signal which energizes the relay in the coupling arrangement, thus coupling the starter motor 8 with the drive shaft 7. At the same time, the starter motor 8 is started, thus providing the starting torque and increasing the rotational speed of the drive shaft 7 and ultimately that of the magnet wheel 3 and the alternator 9 up to the rated rotational speed.

Once the magnet wheel 3 attains the rated rotational speed, the wheel 3 continues its rotation in a steady-state mode at that speed by virtue of the unique arrangement of permanent magnets 4 and the electromagnet 6. In each arrangement, when a permanent magnet 4 on the periphery of the magnet wheel 3 approaches the magnetic flux switch 5, the switch 5 closes and energizes the electromagnet 6, which attract the permanent magnet 4 prior to the one that causes the switch 5 to close. As this magnet 4 moves towards the electromagnet 6, the following permanent magnet 4 moves upward, thereby cause the magnetic flux switch 5 to open, which de-energizes the electromagnet 6. Because of this de-energizing of the electromagnet 6, the permanent magnet 4 which was attracted before passes the electromagnet 6 due to the inertia of the wheel 3.

Referring to FIG. 3, in one exemplary arrangement, there are 12 permanent bar magnets 4, each positioned at 30-degree intervals along the periphery of the wheel 3. Accordingly, for the example wheel illustrated in FIG. 3, the phenomenon described above is repeated twelve times in each 360-degree rotation of the wheel 3, thereby utilizing the magnetic power of the permanent magnets 4 not only for sustaining its own rotation but also for supplying power to the drive shaft 7.

Once the rotational speed of the wheel 3 and the drive shaft 7 has reached the rated speed, the controller 11 de-energizes the relay of the starter arrangement 8, stops powering the motor of the starter 8, and begins providing the excitation current to the alternator 9. The alternator 9 is then in a position to take the load, thereby enabling the controller 11 to start charging the battery 10 and to connect the load to the system.

In another exemplary embodiment, instead of 12 evenly spaced bar magnets 4, the wheel 3 may include any number of permanent magnets that are arranged in a variety of positional configurations. Further, the system may include more than one wheel 4. For example, in one exemplary embodiment, the system includes three wheels 3 that each utilize 45 cylindrical magnets 4, for a total of 135 cylindrical magnets 4. The permanent magnets 4 may be made of any desired magnetic material. In one exemplary embodiment, the permanent magnets 4 include rare earth metal magnets, such as samarium-cobalt magnets and/or neodymium-iron-boron magnets. The selection of the number, type, and configuration of the permanent magnets is generally determined as a result of commercial availability and cost.

In accordance with one or more embodiments of the present invention, one or more permanent magnets may be located outside the first wheel/magnet wheel 3 to aid the electromagnet 6. In particular, this embodiment may be utilized when a control means such as an optical switch, optical sensor, or other switch is used rather than magnet flux switch 5. However, the embodiment may also be used with a magnetic flux.

While the foregoing detailed description has described particular preferred embodiments of this invention, it is to be understood that the above description is illustrative only and not limiting of the disclosed invention. While preferred embodiments of the present invention have been shown and described herein, it will be obvious to those skilled in the art that such embodiments are provided by way of example only. Numerous variations, changes, and substitutions will now occur to those skilled in the art without departing from the invention.

What is claimed is:

1. A system for generating electrical current, comprising:
a first wheel comprising a non-magnetic material;
a drive shaft connected to the first wheel;
a plurality of permanent magnets, each of the plurality of permanent magnets being affixed to a respective interior portion of a periphery of the first wheel;
a first magnetic flux switch positioned parallel to the drive shaft and at a first predetermined distance from a center of the first wheel;
a first electromagnet positioned parallel to the drive shaft and at a second predetermined distance from the center of the first wheel, the electromagnet being electrically coupled to the magnetic flux switch;
an alternator connected to the drive shaft, the alternator having an output port; and
a starter connected to the drive shaft,
wherein when the first wheel rotates about an axis of the drive shaft, as one of the plurality of permanent magnets approaches the first magnetic flux switch, the first magnetic flux switch is configured to close, thereby causing the first electromagnet to be electrically energized, thereby causing the one of the plurality of permanent magnets to move away from the first magnetic flux switch and toward the first electromagnet, thereby causing the first magnetic flux switch to open, thereby causing the first electromagnet to be de-energized; and
wherein an inertia caused by motion of the plurality of permanent magnets causes the drive shaft to rotate, thereby causing the alternator to generate electrical current, and wherein the alternator is further configured to output the generated electrical current via the output port.

2. The system of claim 1, further comprising a starting means coupled to the drive shaft, the starting means being configured to apply an initial torque to the drive shaft.

3. The system of claim 2, further comprising a controller and a battery, the controller being coupled to the starting means, the alternator, the first magnetic flux switch, and the first electromagnet, and the battery being coupled to the controller, wherein the controller is configured to provide a start signal to the starting means and to monitor an operation of the system, and wherein the battery is configured to provide power to the starting means for applying the initial torque and to provide a backup source of power to the system.

4. The system of claim 1, wherein when the first wheel rotates at a rate greater than or equal to a predetermined minimum steady-state rate, an efficiency of outputted generated electrical current is optimized.

5. The system of claim 1, wherein the plurality of permanent magnets includes a plurality of bar magnets positioned in an approximately equal mutual spacing arrangement along the periphery of the first wheel.

6. The system of claim 5, wherein the plurality of bar magnets includes at least twelve bar magnets.

7. The system of claim 1, wherein the plurality of permanent magnets includes a plurality of cylindrical magnets positioned in an approximately equal mutual spacing arrangement along the periphery of the first wheel.

8. The system of claim 1, further comprising a second wheel, a second magnetic flux switch, and a second electromagnet, each being configured substantially identically as the first wheel, the first magnetic flux switch, and the first electromagnet, respectively.

9. The system of claim 1, further comprising a third wheel, a third magnetic flux switch, and a third electromagnet, each being configured substantially identically as the first wheel, the first magnetic flux switch, and the first electromagnet, respectively.

10. The system of claim 9, wherein the plurality of permanent magnets includes a first plurality of cylindrical magnets positioned in an approximately equal mutual spacing arrangement along the periphery of the first wheel and a second plurality of cylindrical magnets positioned in an approximately equal mutual spacing arrangement along the periphery of the second wheel and a third plurality of cylindrical magnets positioned in an approximately equal mutual spacing arrangement along the periphery of the third wheel.

11. The system of claim 10, wherein each of the first, second, and third pluralities of cylindrical magnets includes at least 45 cylindrical magnets.

12. The system of claim 1, wherein each of the plurality of permanent magnets comprises a rare earth metal magnet.

13. The system of claim 12, wherein the each of the plurality of permanent magnets comprises a rare earth metal magnet selected from the group consisting of samarium-cobalt magnets and neodymium-iron-boron magnets.

14. A method of using a first wheel, an electromagnet, a magnetic flux switch, and an alternator to generate electrical current, each of the first wheel and the alternator being mechanically coupled to a drive shaft, the magnetic flux switch being positioned parallel to the drive shaft and at a first predetermined distance from a center of the first wheel, the electromagnet being positioned parallel to the drive shaft and at a second predetermined distance from the center of the first wheel, the electromagnet being electrically coupled to the magnetic flux switch, the first wheel comprising a plurality of permanent magnets, each of the plurality of permanent magnets being affixed to a respective interior portion of a periphery of the first wheel, and the method comprising the steps of:
applying an initial torque to the drive shaft; and
monitoring a rotational rate of the drive shaft,
wherein when the drive shaft rotates, the drive shaft is configured to cause the first wheel to rotate about an axis of the drive shaft at a same rotational rate, thereby causing one of the plurality of permanent magnets to approach the magnetic flux switch, thereby causing the magnetic flux switch to close, thereby causing the electromagnet to be electrically energized, thereby causing the one of the plurality of permanent magnets to move away from the magnetic flux switch and toward the electromagnet, thereby causing the magnetic flux switch to open, thereby causing the electromagnet to be de-energized; and
wherein an inertia caused by motion of the plurality of permanent magnets causes the drive shaft to rotate, thereby causing the alternator to generate electrical current.

15. The method of claim 14, further comprising the steps of:
using a battery to provide power for applying an initial torque and for providing a backup source of power.

16. The method of claim 14, wherein when the first wheel rotates at a rate greater than or equal to a predetermined minimum steady-state rate, an efficiency of generated electrical current is optimized.

17. The method of claim 14, wherein the plurality of permanent magnets includes a plurality of bar magnets positioned in an approximately equal mutual spacing arrangement along the periphery of the first wheel.

18. The method of claim 17, wherein the plurality of bar magnets includes at least twelve bar magnets.

19. The method of claim 14, wherein the plurality of permanent magnets includes a plurality of cylindrical magnets positioned in an approximately equal mutual spacing arrangement along the periphery of the first wheel.

20. A method of using a plurality of wheels, a corresponding plurality of electromagnets, a corresponding plurality of magnetic flux switches, and an alternator to generate electrical current, each of the plurality of wheels and the alternator being mechanically coupled to a drive shaft, each of the plurality of magnetic flux switches being positioned parallel to the drive shaft and at a first predetermined distance from a center of a corresponding one of the plurality of wheels, each of the plurality of electromagnets being positioned parallel to the drive shaft and at a second predetermined distance from the center of a corresponding one of the plurality of wheels, each of the plurality of electromagnets being electrically coupled to the corresponding one of the plurality of magnetic flux switches, each of the plurality of wheels comprising a corresponding plurality of permanent magnets, each of the pluralities of permanent magnets being affixed to a respective interior portion of a periphery of the corresponding one of the plurality of wheels, and the method comprising the steps of:
applying an initial torque to the drive shaft; and
monitoring a rotational rate of the drive shaft,
wherein when the drive shaft rotates, the drive shaft is configured to cause each of the plurality of wheels to rotate about an axis of the drive shaft at a same rotational rate, thereby causing one of each of the pluralities of permanent magnets to approach the corresponding one of the plurality of magnetic flux switches, thereby causing each of the plurality of magnetic flux switches to close, thereby causing the corresponding one of the plurality of electromagnets to be electrically energized, thereby causing the one of each of the pluralities of permanent magnets to move away from the corresponding magnetic flux switch and toward the corresponding electromagnet, thereby causing the corresponding magnetic flux switch to open, thereby causing the corresponding electromagnet to be de-energized; and
wherein an inertia caused by motion of the pluralities of permanent magnets causes the drive shaft to rotate, thereby causing the alternator to generate electrical current.

21. The method of claim 20, wherein each of the pluralities of permanent magnets includes a plurality of cylindrical magnets positioned in an approximately equal mutual spacing arrangement along the periphery of the corresponding wheel.

22. The method of claim 21, wherein each of the pluralities of cylindrical magnets includes at least 45 cylindrical magnets.

23. The method of claim 22, wherein each of the plurality of permanent magnets comprises a rare earth metal magnet.

24. The method of claim 23, wherein the each of the plurality of permanent magnets comprises a rare earth metal magnet selected from the group consisting of samarium-cobalt magnets and neodymium-iron-boron magnets.
